(19) United States
(12) Patent Application Publication
(10) Pub. No.: US 2021/0222045 A1
(43) Pub. Date: Jul. 22, 2021

(54) COMPOSITIONS AND METHODS FOR WELLBORE STRENGTHENING APPLICATIONS

(71) Applicant: Chevron U.S.A. Inc., San Ramon, CA (US)

(72) Inventors: Michael James Fuller, Cypress, TX (US); Robert Neil Trotter, Conroe, TX (US); John Bryan Trenery, JR., Sugar Land, TX (US)

(21) Appl. No.: 17/141,969

(22) Filed: Jan. 5, 2021

Related U.S. Application Data
(60) Provisional application No. 62/962,660, filed on Jan. 17, 2020.

(51) Int. Cl. C09K 8/24; C09K 8/16; C09K 8/508; C09K 8/504; C09K 8/516; E21B 21/00; E21B 43/26

(52) U.S. Cl. CPC C09K 8/24; C09K 8/16; C09K 8/5086; E21B 43/26; C09K 8/516; E21B 21/003; C09K 8/5045

(57) ABSTRACT

The disclosure is related to compositions and methods for strengthening wellbores. Specific embodiments include compositions and uses for self-degrading WBS materials which do not damage a wellbore, thus, leading to increased production.

### CROSS-REFERENCE TO RELATED APPLICATION

The present application claims the benefit of U.S. Provisional Patent Application No. 62/962,660, titled “Compositions and Methods for Wellbore Strengthening Applications” and filed on Jan. 17, 2020; the forgoing application is herein incorporated by reference in full.

### TECHNICAL FIELD

The present disclosure relates generally to compositions and methods for strengthening wellbores, and more specifically to compositions that pack into low-porosity composites in a fracture and increase the hoop stress of a formation and methods associated therewith.

### BACKGROUND

While drilling, a formation zone may be encountered which has a low fracture gradient. In some cases, during drilling, such a low fracture gradient zone is susceptible to the formation of new fractures. Drilling fluid (also referred to as drilling mud) can then leak into the growing fracture and formation causing damage to the formation. To limit drilling fluid loss into the formation, a solid loss-circulation material (LCM) can be added to the drilling fluid which leaks-off into the fracture causing a plug. That is, the LCM limits fluid loss by packing into the fracture and/or bridging across the fracture entry-point. One subset of current LCM includes “wellbore strengthening material” (WBS material) as shown in FIG. 1, which packs to form a low-porosity composite 102 in an induced fracture 104 (often against the fracture-tip 106). The resulting packed fracture accordingly increases the strength of the zone where the fracture formed, making the formation harder to fracture.

Many candidate wells drilled with drilling fluid comprising WBS material have fractures packed with the WBS material, and there are numerous reports of productivity-damage that is likely attributable to the use of the WBS material. In other words, after a well is drilled and when it is time to extract a resource from the formation through the fractures, residual WBS materials packed into fractures can inhibit flow of the resource through the fractures. Some portions of the WBS (often being based on CaCO₃ particles) are soluble in acid, but these particles are often inaccessible by the pre-fracture acid pumped as a part of the fracture pack fluid sequence. Alternative types of currently used WBS materials include graphite and fibers; however, these alternatives comprise acid-insoluble solid materials which have also been found to be damaging to formations in that they inhibit flow through fractures during production.

Limitations of current WBS materials include high residual damage which can damage subsequent productivity of a well; deep-formation damage including cases of uncontrolled fracture growth and damage that enters a propped fracture; WBS material that is insoluble in prefracture acid; and, WBS material that is inaccessible to injected prefracture acid. Thus, there exists a need for alternative WBS materials that avoid these limitations.

### SUMMARY

A general embodiment of the disclosure is a method for controlling fluid loss during drilling, comprising drilling a well in a formation and while drilling the well, circulating a drilling mud through the wellbore, wherein the drilling mud comprises a wellbore strengthening material comprising solid self-degrading wellbore strengthening particles.

Another general embodiment of the disclosure is a drilling mud composition comprising drilling mud and a degrading wellbore strengthening material comprising self-degrading wellbore strengthening particles.

Yet another general embodiment of the disclosure is a wellbore strengthening (WBS) composition comprising a first encapsulated WBS material and a second WBS material.

These and other aspects, objects, features, and embodiments will be apparent from the following description and the appended claims.

### BRIEF DESCRIPTION OF THE DRAWINGS

The drawings illustrate only example embodiments of methods, systems, and devices for compositions and methods for strengthening wellbores and are therefore not to be considered limiting of the scope of the disclosure. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 illustrates a wellbore strengthening material bridged at the entrance of a fracture in accordance with the prior art.

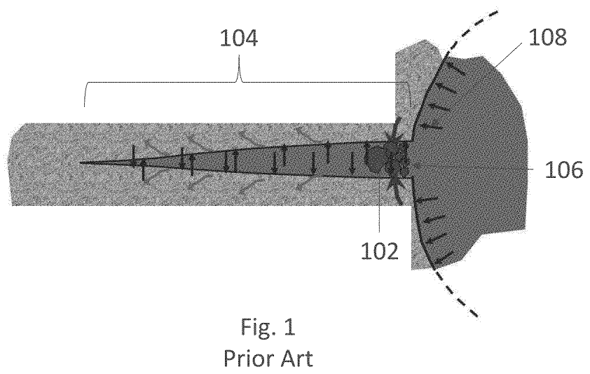

FIGS. 2a-2c are illustrations of different time steps within a wellbore being drilled. FIG. 2a illustrates drilling, fractures formed in the formation near the wellbore due to the drilling, and the circulation direction of drilling mud including degradable wellbore strengthening material. FIG. 2b illustrates degrading wellbore strengthening materials plugging the fractures in accordance with the example embodiments of the present disclosure. FIG. 2c illustrates the degradation over time of the degrading wellbore strengthening materials in accordance with the example embodiments of the present disclosure.

FIG. 3 illustrates the use of a tool to degrade an on-demand degrading wellbore strengthening material within a fracture.

### DETAILED DESCRIPTION OF EXAMPLE EMBODIMENTS

The example embodiments discussed herein are directed to compositions and methods for strengthening wellbores. Specific embodiments include compositions and uses for WBS materials which reduce the occurrence of residual damage to a wellbore and/or reduce hoop stress after degrading, thus, leading to increased production of a resource through fractures in the formation. Embodiments of the disclosure include self-degrading materials and on-demand degrading WBS materials. Embodiments of the disclosure include materials and methods to remove and/or prevent damage associated with WBS, bridging, and loss-circulation materials.

Example embodiments will be described more fully hereinafter, in which example embodiments of systems, apparatuses, compositions, and methods of strengthening a wellbore during drilling are described. It should be understood that such systems, apparatuses, compositions and methods may be embodied in many different forms and should not be construed as limited to the example embodiments set forth herein. Rather, these example embodiments are provided so that this disclosure will be thorough and complete, and will fully convey the scope of the claims to those of ordinary skill in the art. Like, but not necessarily the same, elements in the various figures are denoted by like reference numerals for consistency.

“Near wellbore” as used herein, refers to areas within the formation surrounding the wellbore that are within 1 foot, 10 inches, 8 inches, or 7 inches of the wall of the wellbore.

“Wellbore strengthening materials” or “WBS materials,” as used herein, refers to solid material that is small enough to pack into a near wellbore fracture creating a plug to stop drilling fluid loss into the formation. These materials may also be referred to as loss circulation material, stress cage materials, fracture closure stress modifiers, loss circulation modifiers, materials to stop fracture propagation. In embodiments, the wellbore fracture is an induced fracture, such as a fracture that occurred from drilling. In embodiments, the wellbore strengthening materials are used to bridge pore throats.

“Degrading” when referring to WBS material refers to the WBS material breaking down, either into smaller pieces that can no longer plug a fracture or transitioning from a solid to a liquid or from a solid to liquid-soluble components. “Self-degrading” as used herein, refers to a material that degrades over time when exposed to a downhole environment. Self-degrading may also be referred to as in-situ degrading. For example, the self-degrading WBS material could degrade when exposed to a downhole temperature (elevated or reduced), presence of water, salinity, and/or pressure. “On-demand degradation” as used herein, refers to the process of degrading a WBS material that occurs only when the WBS material is exposed to an external force, such as a heat, gamma-rays, or other force applied from an external tool, etc.

WBS Materials

Materials disclosed herein include self-degrading WBS materials and on-demand degrading WBS materials.

In one embodiment of the disclosure, one or more selections of alternative WBS materials are implemented to serve functionally as a replacement for conventional WBS material. In example embodiments, the sizes, buoyancy, and ability of the replacement WBS material to be pumped and packed into a fracture are comparable to conventional WBS materials that would be used within the well. However, these alternative materials would be designed to undergo self-degradation under downhole conditions or be able to undergo on-demand degradation.

In some embodiments, at minimum, the size of WBS particles are sufficient to enter a drilling induced fracture. In additional embodiments, the WBS particles have a size with at least one dimension that does not bridge outside a fracture. In embodiments, the fracture width is less than 1 inch. In specific embodiments, the fracture width is less than about 4000 μm, less than 2500 μm, less than 2000 μm, or less than 1500 μm. In specific embodiments, the particle size or combination of particle sizes is chosen to minimize the porosity when packed into a fracture. In some embodiments, there is a mixture of particle sizes within the WBS material. In some embodiments, at least one dimension of the average WBS material particle sizes is less than 2,000 microns, less than 1,000 microns, less than 500 microns, or less than 100 microns. In embodiments, the size of the WBS material particles or blend of particle sizes is chosen such that a packed fracture yields low porosity.

In some embodiments, the WBS materials could include any number of shapes including beads, oblong shapes, powders, fibers, plates, flakes, rods, and/or a mixture thereof. In some embodiments, the WBS materials can include hard materials. In some embodiments, the WBS materials can include material that deforms slightly under stress. In some embodiments, the WBS material can include softer material that deforms totally under stress. In some embodiments, the WBS material can include a mixture of WBS material with a material of different resiliency.

In some embodiments, the WBS material particles could be a mixture of different particles. In additional embodiments, the WBS material particles could be a mixture of one or more degradable particle and one or more inert solid. In specific embodiments, the WBS material particles comprises only one type of degradable particle. In some embodiments, the degradation product from the degradable particle could dissolve a secondary material. In some embodiments, the mixtures could comprise cooperative materials, i.e. one material could help the degradation of a second WBS material.

In some embodiments, the packed WBS material in a fracture could include multiple sizes and/or shapes. The sizes and/or shapes can be chosen to produce a tight pack and yield low porosity within a fracture, thus, creating a plug that does not allow fluid to pass from the wellbore into the fracture and then into the formation. The size and mixture of sizes of the degrading WBS material may be designed specific to the near wellbore formation or fracture properties, such as permeability or average pore-throat size.

In embodiments, the degrading WBS material may be suspended in a base fluid, such as drilling fluid. In some embodiments, the degrading WBS material is suspended in a fluid that is then diluted prior to entering the wellbore. In embodiments, the drilling fluid is a water-based mud or an emulsion mud. In embodiments, the WBS material is added to the mud during the entire circulation of the mud. In a specific embodiments, the WBS material is added to the mud in a lower concentration. In some embodiments, the WBS material is added to the mud in a spot pill. In specific embodiments, the WBS material is added to the mud in a higher concentration than when circulated through the mud through the entirety of a drilling process.

Self-Degrading WBS Material

Embodiments of the disclosure include WBS material that comprises WBS particles which self-degrade within a formation at a time that is within the normal operation timing of a well so that the WBS material does not interfere with production of a resource from the formation to the well. For example, the WBS particle self-degrades when exposed to formation conditions in less than 40 days, 20 days, less than 15 days, less than 10 days, less than 5 days, less than 4 days, less than 3 days, less than 2 days, less than one day. In embodiments, the WBS particle does not self-degrade for at least 6 hours, 12 hours, 18 hours, 24 hours, 2 days, 3 days, or 4 days. In some embodiments, the WBS particle degrades when exposed to internal formation elements such as temperature, pH, salinity, pressure, stress, water, and hydrocarbons; the ultimate time required for complete self-degradation depends on these specific conditions applied downhole. In embodiments, the WBS material consists of self-degrading WBS particles. In embodiments, the WBS material essentially consists of self-degrading WBS particles. In embodiments, the WBS material comprises self-degrading WBS particles. Specific WBS self-degrading particles are described below including degradable polymers, degradable metal/alloys, encapsulated material, and hydrocarbon soluble material.

Degradable Polymers

Embodiments of the disclosure are a WBS material which comprises a polymer which degrades through hydrolysis from a solid polymer form into soluble monomers. Examples of these polymers include polylactic acid; polyglycolic acid; polysuccinimide; polyurethane; polyethylene terephthalate; copolymers and other derivatives of these polymers; and mixtures of these polymers or copolymers. In some embodiments, degradable polymers are used within a formation that additionally includes water. In embodiments, within a formation a combination of water and heat can cause the hydrolysis of the polymer backbone, causing the solid polymer to become a liquid and/or water-soluble, thus degrading the solid WBS material. Degradation of the WBS material removes the packed-particle plug within near wellbore fractures, allowing the passage of fluid between the wellbore and the formation, in both directions.

Degradable Metals/Alloys

Embodiments of the disclosure are WBS material which comprises degradable metals (metal alloys). In embodiments, degradable metal WBS material can be used in multistage fracturing operations. In some embodiments, the degradable metal WBS material can be provided as bulk components which will degrade to soluble or gaseous byproducts at downhole conditions. In other embodiments, degradable metal WBS material can be provided in micronized form, which could be deployed in a suitable carrier. Embodiments of degradable metal WBS include magnesium-rich alloys, aluminum-rich alloys, iron-rich alloys, and alloys that contain these materials, their mixtures, and alloyed mixtures containing other metals such as calcium, titanium, manganese, and others. In some embodiments the carrier fluid for these alloy particles is a nonaqueous fluid, an oil-external emulsion, an aqueous fluid, or other fluids. The carrier fluid may require some viscosity to suspend the metal/metal alloy particles, such as a viscosity of at least 100 cP, 50 cp, 40 cP, 25 cP, 10 cP, 5 cP, or 2 cP. In some embodiments, the composition of the dissolvable metal/metal allow is tested with drilling mud to be used to ensure the degradation rate is sufficiently slow to allow sufficient packing in a fractured drilling formation zone and WBS action prior to degradation. In embodiments, once the metal WBS material contacts water or heat within a formation, hydrolysis and temperature can form aqueous salts.

Encapsulated Materials

Embodiments of the disclosure include a WBS material which comprises degradable encapsulated material. In some embodiments, the degradable encapsulated material can contain reactive chemical cores or can have hollow cores.

In embodiments of the disclosure, encapsulated WBS materials can include a) encapsulated active or reactive materials (which could protect the inner core chemicals until the encapsulated shell was breached) or b) encapsulated hollow shells (that are pumped as micronized solid beads but would degrade upon mechanical closure within a fracture). Embodiments of an encapsulated active WBS material include encapsulated acid (which on release reacts with and dissolves other acid-soluble WBS material, dissolves formation damage, or dissolves other acid-soluble damage); encapsulated degradable metal/alloy (for example using encapsulant to protect a fast-degrading alloy from a carrier fluid); and, encapsulated aqueous brine (which could be used to speed degradation of a secondary degradable solid). In some embodiments, encapsulated WBS material could include polymer shells (which may broken mechanically); wax coatings (which could melt and/or solubilize in hydrocarbon); slowly-soluble solids (similar to sugar-coatings in food applications). Encapsulated material that once packed in a fracture and subjected to closure stress would rupture releasing an internal chemical. Encapsulated material that is hollow that upon closure stress ruptures, releasing the packed plug.

Encapsulated WBS material includes a subset of coated WBS materials. In embodiments of a coated WBS material, the capsule could be a soft shell, or shell that does not require significant mechanical degradation of the shell, that releases the core material when subject to formation conditions.

In some embodiments, the WBS material could be a mixture of two or more different WBS materials with one or more of the WBS materials being an encapsulated material. For example, one type of WBS material could be an encapsulated acid and the second type of material could be a non-encapsulated calcium carbonate. In this example, the encapsulated acid and the calcium carbonate would press together within a near wellbore fracture to create a plug, stemming drilling mud fluid loss. Given time, the encapsulated acid would be crushed under formation pressure, releasing the acid. The acid could then degrade the calcium carbonate and additionally help clean the near wellbore fracture. In another embodiment, a first WBS material could be an encapsulated or non-encapsulated metal alloy and a second WBS material could be an encapsulated brine. After time and under pressure the encapsulated brine and metal alloy could rupture, releasing the brine and metal alloy. The salt within the brine would then degrade the metal alloy, degrading the WBS materials and allowing for fluid flow between the wellbore and the formation.

Materials that are Slowly Soluble in Hydrocarbon

Embodiments of the disclosure are WBS materials comprising materials that are slowly soluble in hydrocarbon. Embodiments include the use of solid materials that create a solid bridge within and adjacent to a fracture created during drilling. For example, the material can be an oil-soluble resin (used for diverting fluid), a wax (hydrocarbon soluble waxes), and other similar materials.

On-Demand Degrading WBS Material

Embodiments of the disclosure include WBS material that degrades when exposed to an external trigger. Embodiments of on-demand WBS materials include materials whose degradation would be triggered only on-demand by tools that apply some external force to trigger the degradation of those solids.

Microwave and Heat Susceptible WBS Material

Embodiments of the disclosure include WBS materials comprising microwave and/or heat susceptible particles, such as wax bead/powder particles designed to remain as a solid at bottom hole temperature. Such particles could be triggered to degrade through the use of a downhole heater or a downhole microwave emitter used to elevate the local temperature of the wax above its melting temperature, thus allowing it to mobilize in its molten state.

Embodiments of heat or microwave susceptible particles include microwave susceptible WBS particles blended into a fluid which comprises a viscosifier which comprises microwave susceptible particles and/or a bridging agent which is microwave susceptible. Such microwave susceptible particles lose their solid character during microwave heating, such as wax beads or core-shell capsules (micron sized or nano-sized) that would degrade upon microwave power due to the core material being preferentially susceptible to microwave radiation. In one embodiment, the shell of the core-shell capsule comprises wax and the core comprises water. In other embodiments, plastic materials with a low melting point could be used in place of the wax particles; examples could include polycaprolactone and other plastics with low melting-point. In some embodiments, the melting temperature of the microwave susceptible material is above the bottom hole temperature.

In some embodiments, the microwave or heat susceptible WBS particles comprises a wax, such as a polyether wax, microcrystalline wax, montanic acid/ester wax, ethylene copolymer wax, synthetic wax, natural wax, polyethylene wax, micronized polyethylene, hi-melt crystalline polyethylene, polyolefin wax polymer, polypropylene, or any mixtures thereof. In additional embodiments, the heat susceptible WBS particles has a melting point of between 116-350, for example between 115-175, 175-225, 225-275, 275-325, 300-350, 116-124, 130-150, 150-170, 170-185, 170-190, 180-200, 190-200, 190-210, 210-225, 210-230, 225-250, 235-245, 250-260, 270-290, 215-240, 215-250° F.

Acoustically-Active Solid Material

Embodiments of the disclosure include WBS material which comprises acoustically-active solid particles. In some embodiments, acoustically active WBS particles is a hollow material (or other forms of solid that are susceptible to sonic force). Such particles could be triggered to degrade through the use of a downhole sonic tool to apply acoustic energy to the area where the specific WBS material is deposited in near wellbore fractures.

Embodiments of acoustically-active solid particles includes solid bridging agents that are susceptible to acoustic force. That is, the bridging agent may shatter or disintegrate once subjected to acoustic force. Examples of acoustic susceptible bridging agents are brittle capsules that shatter with sufficient applied acoustic force, such as silica spheres, core-shell capsules with thin plastic coatings, and similar materials.

Gamma-Ray Active Solid Material

Embodiments of the disclosure include WBS material which comprises gamma-ray active solids. In some embodiments, gamma-ray active WBS particles are selected that are susceptible to degradation by subsequent application of the output of a gamma ray source, such as a wireline-deployed gamma ray tool. Examples of gamma-ray solids include precursors to acids, oxidizers, and other reactive chemicals, whose formation of the reactive chemicals only occurs on exposure to gamma-ray radiation). In some embodiments, polymers can be degraded by gamma ray exposure without any additional initiator.

In embodiments, the gamma ray emitting tool applies gamma rays to induce chemical change and/or activation of a WBS material. Gamma rays induce many chemical changes, such as formation of peroxide (oxidizer), formation of acid, and degradation of polymers.

Embodiments of gamma ray active material are WBS particles which comprises polysaccharide polymers, such as starch, xanthan, guar, or others. In embodiments, the WBS particles are chitosan. In embodiments, the WBS material could additionally comprise calcium carbonate solids, which could be removed on-demand by acids formed downhole by gamma ray radiation on the polysaccharide polymers, for example.

In some embodiments, the gamma ray tool may be targeted to break down a gamma ray viscosifier and/or a bridging agent within the WBS material. For example, the bridging agent within the WBS material may be acid soluble and/or a starch which, when combined with another chemical (such as hydrogen peroxide), creates free radicals in acid, which then breaks down the solid WBS material. In embodiments, the gamma ray force would initiate a primary reaction to convert inert precursor into an active chemical, such as acid or oxidizer; these activated components will then undergo the secondary reaction (i.e., acid with CaCO₃ or oxidizer with polysaccharide) to degrade the WBS material. Chitosan, for example, can be degraded through first hydrolyzing water into OH in the presence of small amounts of hydrogen peroxide, then those radicals lead to chain degradation in the chitosan. Gamma ray exposure may also break down polymers without any additional reacting chemicals.

Examples of gamma-ray precursor chemicals which are initially inert include: free radical precursors, such as hydrogen peroxide; gamma ray susceptible FLC bridging agents such as calcium carbonate, other acid soluble solids; gamma ray susceptible FLC viscosifiers such as starch, xanthan, guar, derivatized guar, derivatized cellulose, and others.

Method of Use of Disclosed WBS Material and Compositions

The WBS material of the disclosure can be used when drilling any type of well. In specific embodiments, the WBS material is used within a formation zone of a well which will be subsequently fractured. In some embodiments, the WBS material is used within an open hole well. In embodiments, the WBS material is used within induced fractures, such as those caused by drilling.

In embodiments, the WBS material is added to a drilling fluid, such as a drilling mud. In certain embodiments, the drilling mud can be a water based mud, an emulsion based mud (such as a invert emulsion or an oil-external emulsion), an oil based mud, or a synthetic-based fluid. In embodiments, the WBS material is added to the drilling mud throughout the drilling process. In some embodiments, the WBS material is added to the drilling mud after a leak is detected. In certain embodiments, a low level of WBS material is added to the drilling mud throughout the drilling process and the level of WBS material is increased when a leak is detected or when drilling through a low-porosity formation zone. Embodiments of the use of WBS material and compositions herein have multiple mechanisms for use in loss circulation prevention and wellbore strengthening.

In some embodiments, the WBS material is added directly to drilling mud as a solid or is deployed into the drilling mud as a liquid-borne suspension of solids. In some embodiments, the WBS material is deployed in a liquid that helps degradation of the WBS material, such as brines; or the addition of the WBS material could be followed by a post-flush comprising a liquid that helps degradation of the WBS material. In some embodiments, the WBS material is deployed in low salinity and is then followed by a flush of liquid comprising a high salinity.

Self-degrading WBS material will degrade within the formation given time. In some embodiments, a post flush could be used to help increase the time to degradation; however, it is understood that given sufficient time under formation conditions the WBS material would degrade on its own in a time period of normal well operations. In embodiments using on-demand degradable WBS material, the WBS material needs to be exposed to an external source of force in order to degrade under a normal well operation time period.

Embodiments of deploying a WBS material degrading tool to apply the required force to degrade or remove the on-demand degrading WBS material may be carried out in a number of ways. In some embodiments, the tool may be deployed via wireline in a dedicated trip downhole. In other embodiments, the tool will be deployed via wireline on a tool assembly which includes other downhole tools. In other embodiments, the tool may be deployed as part of the lower completion (disposable) or attached to the washpipe (retrievable). This will allow the action of the tool to clean up WBS material damage during the running of the lower completion. In this embodiment, additional time may be added to the time to run in hole with the tool/completion assembly, to ensure maximum cleanup. In some embodiments, the WBS material degrading tool may be attached to a downhole tool. For example, the WBS material degrading tool may be imbedded in the sand screen. The completion may be designed such that the tool is disposable. That is, where it will remain a part of the lower completion or sand screen through the productive lifetime of the well. Alternatively, the tool may fully or partially comprise degradable solid material, where after activation of the tool to remove WBS material, the tool can then remain downhole and will slowly degrade during production. Alternatively, the tool may remain downhole but will comprise a non-degradable material that will simply reside in the toe or bottom of the wellbore after action (with the wellbore length designed to accommodate storage of this sacrificial tool).

Embodiments of the disclosure include different apparatus and methods of powering the WBS material degrading tool. Embodiments include power applied from the surface, such as through established wireline techniques. Other embodiments include powering the tool from the surface within the lower completion. In other embodiments, the tool may be powered from a self-contained power source that will enter the wellbore with the lower completion/tool assembly during the tool's installation and action. Such power sources include down hole power generators and batteries, for example.

In embodiments of the disclosure, the tool is automatically triggered, such as by reaching a specific depth. In other embodiments of the disclosure the tool is triggered from the surface, such as through signals that are transmitted fiberoptically, through wireless means, and otherwise.

### Additional Example Embodiments

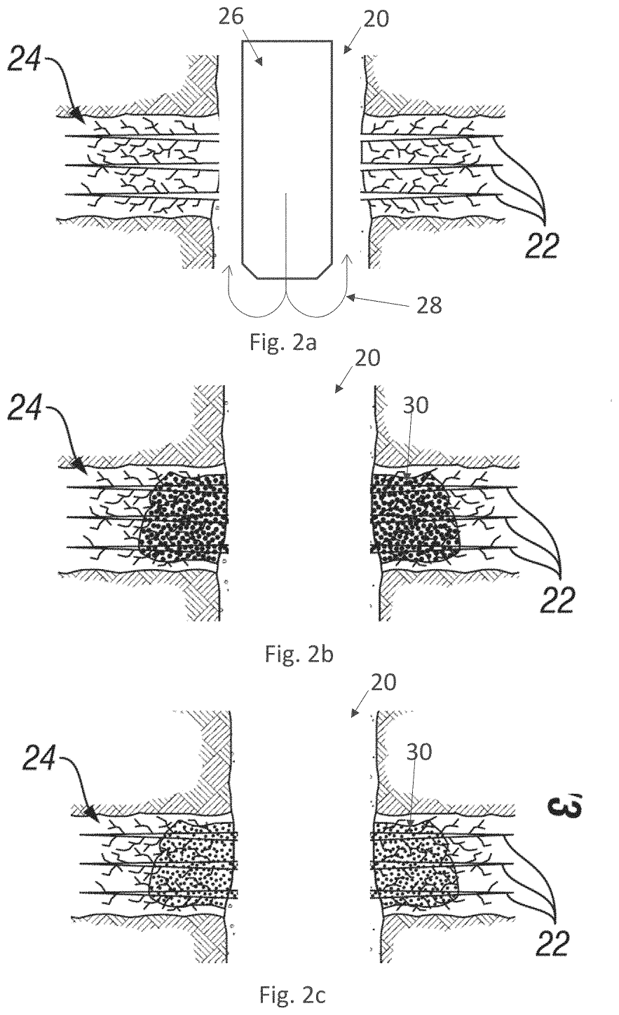

In embodiments, as illustrated in the example of FIGS. 2a, 2b, and 2c, the WBS material is used to seal drilling induced voids in producing zones while drilling is occurring. Drilling a wellbore 20 through production zones can cause fracturing 22 to occur in the production zones 24 (FIG. 2a). These fractures 23 or voids can be in communication with the wellbore and, if not sealed, drilling mud and fluids 28 from the drilling equipment 26 can leak from the wellbore into the production zones clogging the zones. Sealing production zone voids with a WBS material 30, as shown in FIG. 2b, would allow drilling fluids to still circulate up and down within the wellbore 20 without allowing the drilling fluids to leak into and plug the fractures of the production zone of the formation. After drilling is complete, the WBS materials degrade, as shown in FIG. 2c, which would reestablish access to the production zones via the fractures to permit production of a resource from the formation. In embodiments of the disclosure the WBS material properties would be tailored to each drilling application.

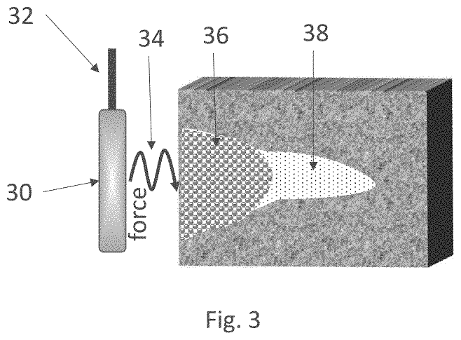

FIG. 3 illustrates an embodiment of an on-demand degrading tool 31 attached on a wireline 32. The on-demand degrading tool 31 generates a force 34 which acts on an on-demand degrading wellbore strengthening material 36 within a fracture 38.

Use of the degradable WBS materials of the disclosure a) reduce overall damage from WBS material (such as damage that could impact the productivity of a cased hole frac pack that are in contact with or otherwise contaminated by WBS material downhole); b) return of the formation stresses to the original state (before the deployment of WBS) prior to initiation of a hydraulic fracture or frac pack i.e. decreases hoop stress caused by the packed material making it easier to fracture the formation; c) degradation of WBS barrier on-demand (in specific embodiments where the degradation occurs through application of external force, such as through use of a downhole tool).

U. S. Pat. Pub. No. 2018/0171750 and U.S. Pat. Pub. No. 2016/0194546 are herein incorporated by reference in full.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for controlling fluid loss during drilling, comprising:
drilling a well in a formation; and
while drilling the well, circulating a drilling mud through the wellbore, wherein the drilling mud comprises a wellbore strengthening material comprising solid self-degrading wellbore strengthening particles.

2. The method of claim 1, wherein the degrading wellbore strengthening particles are one or more of polylactic acid, polyglycolic acid, polysuccinimide, polyurethane, and polyethylene terephthalate.

3. The method of claim 1, wherein the degrading wellbore strengthening particles are one or more of a magnesium-rich alloy, an aluminum-rich alloy, an iron-rich alloy, calcium, titanium, and manganese.

4. The method of claim 3, wherein the degrading wellbore strengthening particles are an encapsulated material.

5. The method of claim 3, wherein the degrading wellbore strengthening particles are soluble in hydrocarbons.

6. The method of claim 1, wherein wellbore strengthening material further comprises on-demand degrading wellbore strengthening particles.

7. The method of claim 6, wherein the on-demand degrading wellbore strengthening particles are wax.

8. The method of claim 7, wherein the wax comprises one or more of polyether wax, microcrystalline wax, montanic acid/ester wax, ethylene copolymer wax, synthetic wax, natural wax, polyethylene wax, micronized polyethylene, hi-melt crystalline polyethylene, polyolefin wax polymer, and polypropylene.

9. The method of claim 1, wherein the wellbore strengthening material penetrates no more than at least 6 inches, 9 inches, 1 foot, 1.5 feet, or 2 feet into the formation from the wellbore.

10. The method of claim 1, further comprising fracturing a zone of the formation after drilling the well.

11. A drilling mud composition comprising:
drilling mud; and
a degrading wellbore strengthening material comprising self-degrading wellbore strengthening particles.

12. The drilling mud composition of claim 11, wherein the self-degrading wellbore strengthening particles are one or more of polylactic acid, polyglycolic acid, polysuccinimide, polyurethane, and polyethylene terephthalate.

13. The drilling mud composition of claim 11, wherein the self-degrading wellbore strengthening particles are one or more of a magnesium-rich alloy, an aluminum-rich alloy, an iron-rich alloy, calcium, titanium, and manganese.

14. The drilling mud composition of claim 11, wherein the self-degrading wellbore strengthening particles are an encapsulated material.

15. The drilling mud composition of claim 11, wherein the self-degrading wellbore strengthening particles are soluble in hydrocarbons

16. The drilling mud composition of claim 11, wherein the wellbore strengthening material further comprises on-demand degrading particles.

17. The drilling mud composition of claim 16, wherein the on-demand degrading wellbore strengthening particles are wax.

18. A wellbore strengthening (WBS) composition comprising:
a first encapsulated WBS material; and
a second WBS material.

19. The wellbore strengthening composition of claim 18, wherein the first encapsulated WBS material comprises a brine and the second WBS material comprises a metal alloy.

20. The wellbore strengthening composition of claim 18, wherein the first encapsulated WBS material comprises an acid and the second WBS material comprises calcium carbonate.
